(19) United States
(12) Patent Application Publication
(10) Pub. No.: US 2017/0277619 A1
(43) Pub. Date: Sep. 28, 2017

(54) SYSTEM AND METHOD FOR DEBUGGING ROBOT BASED ON ARTIFICIAL INTELLIGENCE

(71) Applicant: BEIJING BAIDU NETCOM SCIENCE AND TECHNOLOGY CO., LTD., Beijing (CN)

(72) Inventors: Yao LIU, Beijing (CN); Lun ZHANG, Beijing (CN); Qian XU, Beijing (CN); Zhihao WANG, Beijing (CN); Fuxiang LI, Beijing (CN); Jing BAI, Beijing (CN); Zheng LI, Beijing (CN)

(21) Appl. No.: 15/428,051

(22) Filed: Feb. 8, 2017

(30) Foreign Application Priority Data
Mar. 22, 2016 (CN) 201610166242.7

(51) Int. Cl. G06F 11/36; G06N 5/02

(52) U.S. Cl. CPC G06F 11/366; G06N 5/022; H04W 4/008

(57) ABSTRACT

The present disclosure provides a system and a method for debugging a robot based on artificial intelligence. The system includes: a mobile terminal; and the robot, in which the mobile terminal and the robot communicate with each other wirelessly, and the mobile terminal is configured to set a state parameter of each function node of the robot, and to send a control command to the robot according to the state parameter of each function node, so as to control the robot to perform a test.

### CROSS-REFERENCE TO RELATED APPLICATIONS

This application is based on and claims a priority to Chinese Patent Application Serial No. 201610166242.7, filed on Mar. 22, 2016, the entire content of which is incorporated herein by reference.

### FIELD

The present disclosure relates to the field of artificial intelligence technology, and more particularly to a system for debugging a robot based on artificial intelligence and a method for debugging a robot based on artificial intelligence.

### BACKGROUND

Artificial intelligence (AI for short) is a new technical science studying and developing theories, methods, techniques and application systems for simulating, extending and expanding human intelligence. The artificial intelligence is a branch of computer science, which attempts to know the essence of intelligence and to produce a new intelligent machine capable of acting in a same way as human intelligence. The researches in this field include robots, speech recognition, image recognition, natural language processing and expert systems, etc. The most important aspect of the artificial intelligence is the speech recognition.

The robots, which are one kind of machine devices assisting or replacing human work, may help human to work, such as do housework, participate in a rescue. With the popularity of the robots, people's requirements for functions of the robots are increasing. In order to realize different functions of the robots, bottom-driven parameters and relevant codes of the robots are modified with relevant algorithms (such as a motor driven PID algorithm).

However, in the way of modifying the bottom-driven parameters and the relevant codes to realize the different functions of the robots, relevant chips of the robots need to be disassembled for being burned again, which brings inconvenience in relevant debugging such as a function test of the robots.

### SUMMARY

The present disclosure aims to solve at least one of the above problems to at least some extent.

Accordingly, a first objective of the present disclosure is to provide a system for debugging a robot based on artificial intelligence, which realizes an information interaction between a mobile terminal and the robot in a wireless manner, and a debugging of the robot on the mobile terminal side, thereby improving debugging efficiency of the robot and saving resources.

A second objective of the present disclosure is to provide a method for debugging a robot based on artificial intelligence.

In order to realize the above objectives, a system for debugging a robot based on artificial intelligence according to embodiments of a first aspect of the present disclosure includes: a mobile terminal; and the robot, in which the mobile terminal and the robot communicate with each other wirelessly, and the mobile terminal is configured to set a state parameter of each function node of the robot, and to send a control command to the robot according to the state parameter of each function node, so as to control the robot to perform a test.

In order to realize the above objectives, a method for debugging a robot based on artificial intelligence according to embodiments of a second aspect of the present disclosure is provided. The method is applied to a mobile terminal, in which the mobile terminal and the robot communicate with each other wirelessly. The method includes: setting by the mobile terminal a state parameter of each function node of the robot; and sending by the mobile terminal a control command to the robot according to the state parameter of each function node, so as to control the robot to perform a test.

In order to realize above objectives, another method for debugging a robot based on artificial intelligence according to embodiments of a third aspect of the present disclosure is provided. The method is applied to the robot, in which a mobile terminal and the robot communicate with each other wirelessly, and the method includes: identifying, by the robot, the mobile terminal so as to be paired with the mobile terminal; receiving, by the robot, a control command sent by the mobile terminal; and controlling, by the robot, the each function node to complete a respective function according to the control command.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

FIG. 1 is a block diagram illustrating a system for debugging a robot based on artificial intelligence according to an example embodiment of the present disclosure;

FIG. 2 is a block diagram illustrating a system for debugging a robot based on artificial intelligence according to a specific example embodiment of the present disclosure;

FIG. 3 is a block diagram illustrating a system for debugging a robot based on artificial intelligence according to another specific example embodiment of the present disclosure;

FIG. 4 is a flow chart showing a method for debugging a robot based on artificial intelligence according to an example embodiment of the present disclosure;

FIG. 5 is a flow chart showing a method for debugging a robot based on artificial intelligence according to a specific example embodiment of the present disclosure; and

FIG. 6 is a flow chart showing a method for debugging a robot based on artificial intelligence according to another specific example embodiment of the present disclosure.

### DETAILED DESCRIPTION

Reference will be made in detail to embodiments of the present disclosure. The same or similar elements and the elements having same or similar functions are denoted by like reference numerals throughout the descriptions. The embodiments described herein with reference to drawings are explanatory, illustrative, and used to generally understand the present disclosure. The embodiments shall not be construed to limit the present disclosure. In contrast, the present disclosure may include alternatives, modifications and equivalents within the spirit and scope of the appended claims.

In addition, terms such as “first” and “second” are used herein for purposes of description and are not intended to indicate or imply relative importance or significance. In the description of the present disclosure, it should be understood that, unless specified or limited otherwise, the terms “mounted,” “connected,” and “coupled” and variations thereof are used broadly and encompass such as mechanical or electrical mountings, connections and couplings, also can be inner mountings, connections and couplings of two components, and further can be direct and indirect mountings, connections, and couplings, which can be understood by those skilled in the art according to the detail embodiment of the present disclosure. In the description of the present disclosure, “a plurality of” means two or more, unless specified otherwise.

The system and the method for debugging a robot based on artificial intelligence according to embodiments of the present disclosure will be described with reference to drawings as follows. It should be noted that, in the present disclosure, the mobile terminal may be a device with various operating systems and a display screen, for example, a mobile phone, a tablet PC, a personal digital assistant, a wearable device (such as smart bracelet, smart watch, smart glasses, etc.), etc.

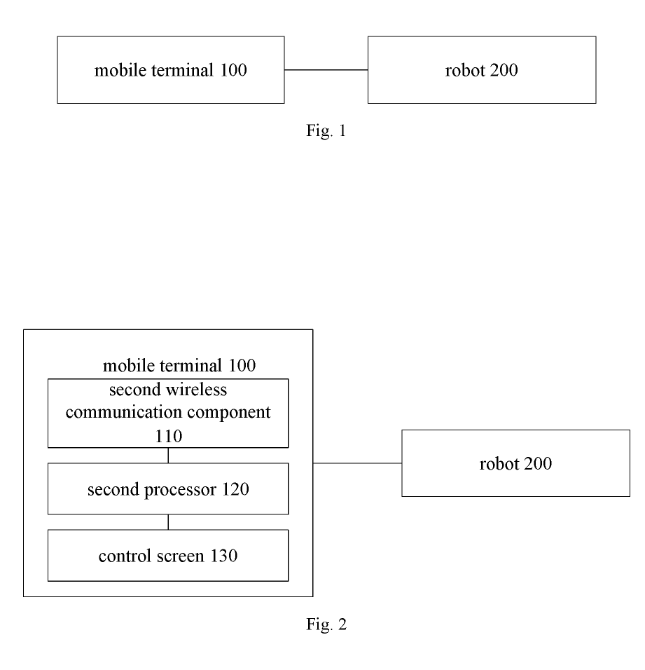

FIG. 1 is a block diagram illustrating a system for debugging a robot based on artificial intelligence according to an example embodiment of the present disclosure.

As shown in FIG. 1, the system for debugging a robot based on artificial intelligence includes a mobile terminal 100 and the robot 200.

On one hand, in order to facilitate the description, the system for debugging a robot based on artificial intelligence will be described on the mobile terminal 100 side.

As an example embodiment, the mobile terminal 100 and the robot 200 communicate with each other wirelessly. The mobile terminal 100 is configured to set a state parameter of each function node of the robot 200, and to send a control command to the robot 200 according to the state parameter of each function node, so as to control the robot 200 to perform a corresponding test. The above function nodes of the robot 200 include at least one of a power management node for controlling a power source of the robot 200, a motion control node for controlling motions of the robot 200 and a display control node for controlling display components (such as an indicator) of the robot 200.

In this example embodiment, the mobile terminal 100 may realize the corresponding text on the robot 200 by setting the state parameter of each function node of the robot 200 and sending the control command. For example, movement parameters of the upper limb of the robot 200 may be modified on the mobile terminal 100 so as to control movements of the upper limb of the robot 200, movement velocity parameters of the robot 200 may be modified on the mobile terminal 100 so as to control the movement velocity of the robot 200, or flashing time parameters of a light of the robot 200 may be modified on the mobile terminal 100 so as to control the light of the robot 200 to flash.

Specifically, FIG. 2 is a block diagram illustrating a system for debugging a robot based on artificial intelligence according to a specific example embodiment of the present disclosure. As shown in FIG. 2, the mobile terminal 100 includes a second wireless communication component 110, a second processor 120 and a control screen 130. The second processor 120 is connected with the second wireless communication component 110 and the control screen 130 respectively.

As an example embodiment, the control screen 130 is configured to set the state parameter of each function node of the robot 200 and to send the state parameter of each function node to the second processor 120.

It should be understood that, the control screen 130 is provided with a setting component for setting the state parameter of each function node of the robot 200. A user may realize the debugging for the state parameters of the robot 200 on this control screen 130. The user may set a value of the state parameter of each function node of the robot 200 on this setting component and then the value of the state parameter of each function node may be sent to the second processor 120, so as to realize the setting of the state parameter of each function node of the robot 200 on the mobile terminal 100.

Further, the second processor 120 is configured to generate the control command according to the state parameter of each function node and to send the control command to the second wireless communication component 110.

The second processor 120 generates the corresponding control command according to the received state parameter of each function node of the robot 200, which is set by the user on the control screen 130. The control command may be identified by the robot 200 and sent to the second wireless communication component 110. The second wireless communication component 110 may be a component which can realize the wireless connection between the robot 200 and the mobile terminal 100, such as a Bluetooth component, a WIFI component or a mobile communication component.

Moreover, the second wireless communication component 110 is configured to send the received control command to the robot 200.

The state parameter of each function node of the robot 200 may be set on the control screen 130 of the terminal control 100, and then the state parameter is sent to the second processor 120 to generate the control command, and then the control command is sent to the second wireless communication component 110, such that the second wireless communication component 110 sends the control command to the robot 200, so as to realize a control of each function node of the robot 200 on the mobile terminal 100 side.

In order to ensure that the debugging on the robot 200 performed by the mobile terminal 100 meets a real-time state of the robot 200, and avoid the situation that the setting of the state parameters of the robot 200 implemented on the mobile terminal 100 does not meet the real-time state of the robot 200, the mobile terminal 100 receives a real-time state parameter of each function node sent by the robot 200.

As another example embodiment, the second wireless communication component 110 is further configured to receive the real-time state parameter of each function node sent by the robot 200 and to send the real-time state parameter of each function node to the second processor 120.

Specifically, in order to avoid a situation that the current setting of the state parameters of the robot 200 implemented on the mobile terminal 100 does not meet the real-time state of the robot 200, for example, the setting of increasing a value of the state parameter of the movement velocity of robot 200 implemented on the mobile terminal 100 does not meet the real-time state that the current state parameter of the movement velocity of the robot 200 has already reached a maximum value, the second wireless communication component 110 receives the real-time state parameter of each function node sent by the robot 200 and sends the real-time state parameter of each function node to the second processor 120, so that the second processor 120 may further process and parse it.

In this example embodiment, the second processor 120 is further configured to calculate the received real-time state parameter of each function node, and to send a calculation result to the control screen 130.

It should be understood that, the second processor 120 sends the calculation result to the control screen 130 after calculating (such as parsing, encrypting and packaging) the received real-time state parameter of each function node, so that the control screen 130 displays the real-time state parameter of the robot 200 to a user.

The control screen 130 is further configured to display information according to the calculation result, and to monitor each function node in real time.

As an example embodiment, the control screen 130 may display the calculation result of the real-time state parameter of the robot 200 in the display screen of the mobile terminal 100 in a form of waveform, a list of numbers or the like, for example, the state parameter (such as the power source, and the movement velocity) of the robot 200 may be displayed on the control screen 130 in a form of waveform, so that the real-time monitoring of each function node of the robot 200 may be completed, thereby ensuring that the user may set the state parameters of the robot 200 on the mobile terminal 100 in accordance with the real-time state parameters of the robot 200.

As an example embodiment, in order to ensure that the debugging on the robot 200 performed by the mobile terminal 100 meets a real-time state of the robot 200, the mobile terminal 100 is further configured to receive a real-time state parameter of each function node sent by the robot 200, and to monitor a test process of the robot 200 according to the real-time state parameter of each function node.

On the other hand, for ease of explanation, the system for debugging a robot based on artificial intelligence will be described on the robot 200 side.

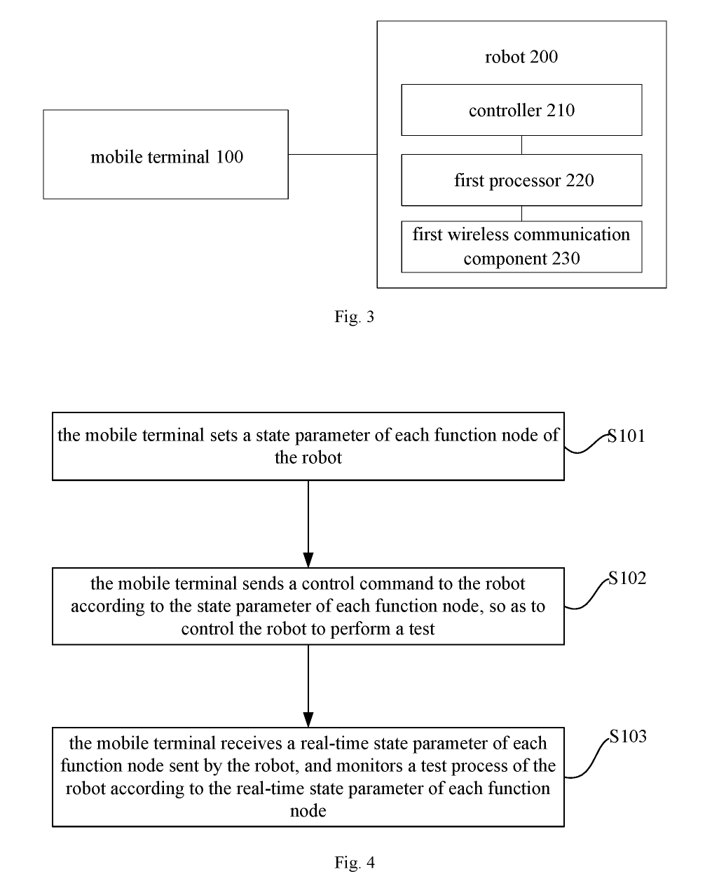

Specifically, as an example embodiment, FIG. 3 is a block diagram illustrating a system for debugging a robot based on artificial intelligence according to another specific example embodiment of the present disclosure. Based on FIG. 1, as shown in FIG. 3, the robot 200 includes a controller 210, a first processor 220 and a first wireless communication component 230.

In this example embodiment, the first processor 220 is connected with the controller 210 and the first wireless communication component 230 respectively. The first wireless communication component 230 may be a component which can realize the wireless connection between the robot 200 and the mobile terminal 100, such as a Bluetooth component, a WIFI component or a mobile communication component. The first wireless communication component 230 is configured to identify the mobile terminal 100 and to be paired with the mobile terminal 100, and to receive the control command sent by the mobile terminal 100 and to send the control command to the first processor 220.

It should be understood that, in order to realize the debugging on the robot 200 performed by the mobile terminal 100, via the first wireless communication component 230, the robot 200 realizes the pair connection with the mobile terminal 100, receives the control command sent by the mobile terminal 100 for controlling the state parameter of each function node and packages the control command and sends it to the first processor 220.

The first processor 220 is configured to send the control command to the controller 210.

Specifically, the first processor 220 parses the received control command and then sends it to the controller 210, so that the controller 210 further controls each function node of the robot 200 according to the control command sent by the mobile terminal 100.

The controller 210 is configured to receive the control command and to control each function node to complete a respective function according to the control command.

Specifically, the controller 210 controls each function node of the robot 200 to complete the corresponding function according to the received control command, for example, if the received control command is to control the upper limb of the robot 200 to rise up, the controller 210 controls the upper limb of the robot 200 to perform a lift movement according to this control command.

In order to enable the mobile terminal 100 to control the function of each function node of the robot 200 according to the real-time state parameters of the robot 200, the robot 200 needs to collect the state parameter of each function node in real time and send the state parameter of each function node to the mobile terminal 100.

As another example embodiment, the controller 210 is further configured to send a real-time state parameter of each function node to the first processor 220.

In this example embodiment, the controller 210 communicates with each function node of the robot 200 and obtains the real-time state parameter of each function node, and further sends the real-time state parameter of each function node to the first processor 220, so that the first processor 220 may process the real-time state parameter of each function node.

Further, the first processor 220 is further configured to send the real-time state parameter of each function node to the first wireless communication component 230.

In this example embodiment, the first processor 220 sends the received real-time state parameter of each function node of the robot 200 to the first wireless communication component 230, so that the first wireless communication component 230 feeds the real-time state parameter of each function node of the robot 200 back to the mobile terminal 100.

Specifically, the first wireless communication component 230 is configured to identify the mobile terminal 100 and to be paired with the mobile terminal 100, and to send the real-time state parameter of each function node to the mobile terminal 100. Further, the first wireless communication component 230 feeds the real-time state parameter of each function node of the robot 200 back to the mobile terminal 100 via the wireless connection with the mobile terminal 100.

As an example embodiment, in addition to accepting a test initiated by the mobile terminal 100 such as receiving the active control command to the robot 200 sent by the mobile terminal 100, the robot 200 may also send a request to the mobile terminal 100 actively, so as to ask the mobile terminal 100 to perform a test on it. The first processor 220 is further configured to receive a command request of each function node sent by the controller 230, and to send the command request of each function node to the first wireless communication component 230. The first wireless communication component 230 is further configured to send the command request of each function node to the mobile terminal 100.

For example, the controller 210 sends a command request of adjusting the velocity to the first processor 220, and the first processor 220 processes this command request and then sends it to the first wireless communication component 230. Further, the first wireless communication component 230 sends the received command request of each function node to the mobile terminal 100, and then the mobile terminal 100 parses this command request and responds to it.

In conclusion, With the system for debugging a robot based on artificial intelligence according to embodiments of the present disclosure, the mobile terminal and the robot communicate with each other wirelessly, so that the state parameter of each function node of the robot may be set via the mobile terminal, and the control command may be sent to the robot according to the state parameter of each function node, so as to perform the corresponding test on the robot. By debugging the robot on the carry-home mobile terminal side, debugging efficiency of the robot may be improved and resources may be saved.

Embodiments of the present disclosure also provide a method for debugging a robot based on artificial intelligence. This method is applied to a mobile terminal. The mobile terminal may communicate with a robot in a wireless manner. As shown in FIG. 4, the method includes following acts.

In block S101, the mobile terminal sets a state parameter of each function node of the robot.

In block S102, the mobile terminal sends a control command to the robot according to the state parameter of each function node, so as to control the robot to perform a test.

In example embodiments of the present disclosure, the method further includes following acts.

In block S103, the mobile terminal receives a real-time state parameter of each function node sent by the robot, and monitors a test process of the robot according to the real-time state parameter of each function node.

In example embodiments of the present disclosure, the function nodes include at least one of a power management node, a motion control node and a display control node.

In example embodiments of the present disclosure, the mobile terminal includes: a second wireless communication component, a second processor and a control screen, the second processor is connected with the second wireless communication component and the control screen respectively.

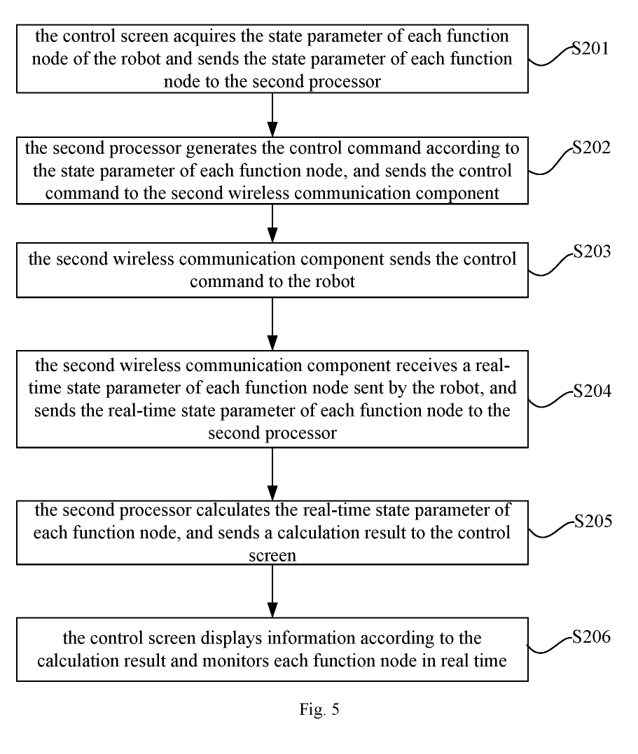

As shown in FIG. 5, the method may be implemented by the mobile terminal as follows.

In block S201, the control screen acquires the state parameter of each function node of the robot and sends the state parameter of each function node to the second processor.

In block S202, the second processor generates the control command according to the state parameter of each function node, and sends the control command to the second wireless communication component.

In block S203, the second wireless communication component sends the control command to the robot.

In example embodiments of the present disclosure, the method further includes following acts.

In block S204, the second wireless communication component receives a real-time state parameter of each function node sent by the robot, and sends the real-time state parameter of each function node to the second processor.

In block S205, the second processor calculates the real-time state parameter of each function node, and sends a calculation result to the control screen.

In block S206, the control screen displays information according to the calculation result and monitors each function node in real time.

In example embodiments of the present disclosure, the second wireless communication component includes: a Bluetooth component, a WIFI component or a mobile communication component.

Embodiments of the present disclosure also provide a method for debugging a robot based on artificial intelligence. This method is applied to a robot which may communicate with a mobile terminal in a wireless manner.

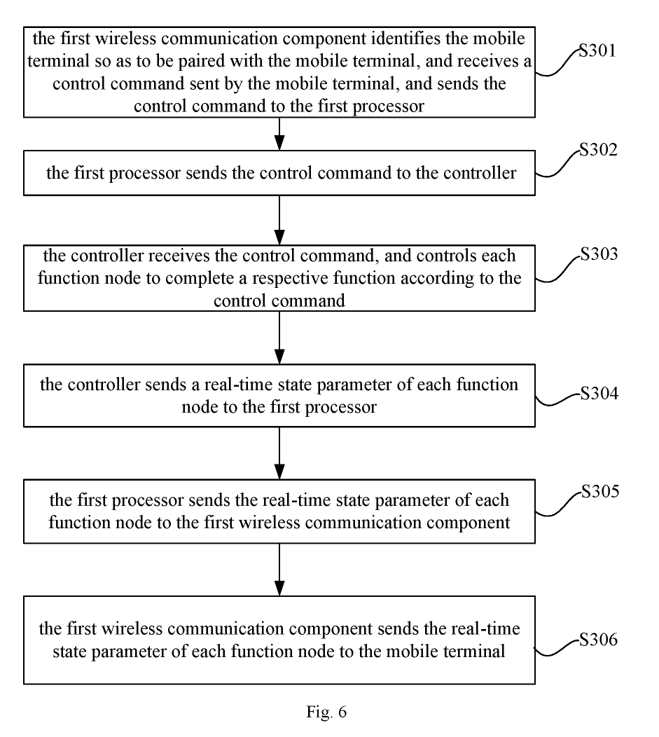

In an example embodiment, the robot includes: a controller, a first processor and a first wireless communication component, and the first processor is connected with the controller and the first wireless communication component respectively. As shown in FIG. 6, the method may be implemented by the robot as follows.

In block S301, the first wireless communication component identifies the mobile terminal so as to be paired with the mobile terminal, and receives a control command sent by the mobile terminal, and sends the control command to the first processor.

In block S302, the first processor sends the control command to the controller.

In block S303, the controller receives the control command, and controls each function node to complete a respective function according to the control command.

In example embodiments of the present disclosure, the method further includes following acts.

In block S304, the controller sends a real-time state parameter of each function node to the first processor.

In block S305, the first processor sends the real-time state parameter of each function node to the first wireless communication component.

In block S306, the first wireless communication component sends the real-time state parameter of each function node to the mobile terminal.

In example embodiments of the present disclosure, the method further includes: receiving, by the first processor, a command request of each function node sent by the controller; sending, by the first processor, the command request of each function node to the first wireless communication component; and sending, by the first wireless communication component, the command request of each function node to the mobile terminal.

In example embodiments of the present disclosure, the first wireless communication component includes: a Bluetooth component, a WIFI component or a mobile communication component.

It should be understood that, regarding the methods in the above embodiments, reference can be made to the system embodiments, which are not elaborated herein again.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from scope of the present disclosure.

What is claimed is:

1. A system for debugging a robot based on artificial intelligence, comprising:
a mobile terminal; and
the robot, wherein
the mobile terminal and the robot communicate with each other wirelessly, and
the mobile terminal is configured to set a state parameter of each function node of the robot, and to send a control command to the robot according to the state parameter of each function node, so as to control the robot to perform a test.

2. The system according to claim 1, wherein
the mobile terminal is further configured to receive a real-time state parameter of each function node sent by the robot, and to monitor a test process of the robot according to the real-time state parameter of each function node.

3. The system according to claim 1, wherein the each function node comprises at least one of a power management node, a motion control node and a display control node.

4. The system according to claim 1, wherein the robot comprises: a controller, a first processor and a first wireless communication component, wherein
the first processor is connected with the controller and the first wireless communication component respectively,
the first wireless communication component is configured to identify the mobile terminal and to be paired with the mobile terminal, and to receive the control command sent by the mobile terminal and to send the control command to the first processor;
the first processor is configured to send the control command to the controller; and
the controller is configured to receive the control command and to control the each function node to complete a respective function according to the control command.

5. The system according to claim 4, wherein
the controller is further configured to send a real-time state parameter of each function node to the first processor;
the first processor is further configured to send the real-time state parameter of each function node to the first wireless communication component; and
the first wireless communication component is further configured to send the real-time state parameter of each function node to the mobile terminal.

6. The system according to claim 4, wherein
the first processor is further configured to receive a command request of each function node sent by the controller, and to send the command request of each function node to the first wireless communication component; and
the first wireless communication component is further configured to send the command request of each function node to the mobile terminal.

7. The system according to claim 4, wherein the first wireless communication component comprises:
at least one of a Bluetooth component, a WIFI component and a mobile communication component.

8. The system according to claim 1, wherein the mobile terminal comprises: a second wireless communication component, a second processor and a control screen, wherein
the second processor is connected with the second wireless communication component and the control screen respectively,
the control screen is configured to set the state parameter of each function node of the robot and to send the state parameter of each function node to the second processor;
the second processor is configured to generate the control command according to the state parameter of each function node and to send the control command to the second wireless communication component; and
the second wireless communication component is configured to send the control command to the robot.

9. The system according to claim 8, wherein
the second wireless communication component is further configured to receive a real-time state parameter of each function node sent by the robot and to send the real-time state parameter of each function node to the second processor;
the second processor is further configured to calculate the real-time state parameter of each function node, and to send a calculation result to the control screen; and
the control screen is further configured to display information according to the calculation result, and to monitor the each function node in real time.

10. The system according to claim 8, wherein the second wireless communication component comprises:
at least one of a Bluetooth component, a WIFI component and a mobile communication component.

11. A method for debugging a robot based on artificial intelligence, applied to a mobile terminal, wherein the mobile terminal and the robot communicate with each other wirelessly, and the method comprises:
setting, by the mobile terminal, a state parameter of each function node of the robot; and
sending, by the mobile terminal, a control command to the robot according to the state parameter of each function node, so as to control the robot to perform a test.

12. The method according to claim 11, further comprising:
receiving, by the mobile terminal, a real-time state parameter of each function node sent by the robot; and
monitoring, by the mobile terminal, a test process of the robot according to the real-time state parameter of each function node.

13. The method according to claim 11, wherein the each function node comprises at least one of a power management node, a motion control node and a display control node.

14. The method according to claim 11, further comprising:
generating, by the mobile terminal, the control command according to the state parameter of each function node.

15. The method according to claim 12, further comprising:
calculating, by the mobile terminal, the real-time state parameter of each function node;
displaying, by the mobile terminal, information according to a calculation result; and
monitoring, by the mobile terminal, each function node in real time.

16. A method for debugging a robot based on artificial intelligence, applied to the robot, the robot and a mobile terminal communicate with each other wirelessly, and the method comprises:
identifying, by the robot, the mobile terminal to be paired with the mobile terminal;
receiving, by the robot, a control command sent by the mobile terminal;
controlling, by the robot, the each function node to complete a respective function according to the control command.

17. The method according to claim 16, further comprising:
sending, by the robot, a real-time state parameter of each function node to the mobile terminal.

18. The method according to claim 16, further comprising:
sending, by the robot, a command request of each function node to the mobile terminal.
